(19) United States
(12) Patent Application Publication
(10) Pub. No.: US 2005/0141480 A1
(43) Pub. Date: Jun. 30, 2005

(54) Apparatus and method for transmitting data between wireless and wired networks

(75) Inventors: Ho Jin, Yongin-si (KR); Seong-hee Lee, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/020,185

(22) Filed: Dec. 27, 2004

(30) Foreign Application Priority Data
Dec. 29, 2003 (KR) 10-2003-0098679

(51) Int. Cl. H04L 12/28

(52) U.S. Cl. 370/351

(57) ABSTRACT

An apparatus and method for transmitting multimedia data between wireless and wired networks. The method includes receiving frames of a first communication protocol type from a first network and converting the received frames into frames of a second communication protocol type, determining the transmission priority order of the frames that are converted into the second communication protocol type, based on packet information of the received frames, and transmitting the frames to a second network based on the determined transmission priority order. In the method, a transmission priority order is determined based on a differentiated services field codepoint (DSCP) value in a type of service (ToS) of an IP packet when converting frames of a first protocol type, which is the IEEE 802.3 protocol, into those of a second protocol type, which is IEEE 802.11 protocol, thereby securing the QoS of the transmission.

### CROSS-REFERENCE TO RELATED APPLICATION

This application claims priority from Korean Patent Application No. 10-2003-0098679 filed on Dec. 29, 2003 in the Korean Intellectual Property Office, the disclosure of which is incorporated herein by reference in its entirety.

### BACKGROUND OF THE INVENTION

1. Field of the Invention

The present invention relates to an apparatus and method for transmitting multimedia data between wireless and wired networks, and more particularly, to an apparatus and method for transmitting multimedia data based on transmission priority for improvement of quality of service (QoS) between an infrastructure mode wireless network and a wired network, when retransmitting at an access point (AP) by using a differentiated service protocol, a network layer protocol. (i.e., the third layer) of the open systems interconnection (OSI) model.

2. Description of the Related Art

FIG. 1 illustrates conventional wireless communication systems under an infrastructure mode and an ad-hoc mode. Referring to FIG. 1, a wireless LAN (WLAN) allows stations within a predetermined distance of one another to wirelessly send and receive data to and from one another without the need for floor wiring similar to that of wired Ethernet. Thus, within the wireless LAN, stations wirelessly communicate with one another so they are free to move from place to place.

In general, the Institute of Electrical and Electronic Engineers (IEEE) standard for WLANs, IEEE 802.11, currently provides protocols for a medium access control (MAC) and a physical (PHY) layer. The IEEE 802.11 WLAN is constructed of a Basic Service Set (BSS), which is defined as a group of stations that are under the control of a single coordination function.

The current WLAN standard provides for two types of networks: an infrastructure mode and an ad-hoc mode. In the infrastructure mode, the network is configured such that a wireless station can communicate with another wireless station, for example, a notebook computer or a PDA, enabling interface with the WLAN, through an access point (AP). The AP converts a frame of the IEEE 802.11 WLAN into another format frame, that is, bridges wireless and wired networks. In the ad-hoc mode, stations can communicate with other stations using a wireless network card without an AP.

In other words, the ad-hoc mode enables a station to communicate with another station directly, without the use of an access point. The infrastructure network configuration uses an access point that bridges a station with a wired network. In the infrastructure mode, communication is established between the station and the AP, not between the station with another station.

The MAC layer basically provides a distributed coordination function (DCF) based on a carrier sense multiple access with collision avoidance (CSMA/CA) protocol.

In addition, a basic MAC structure is formed of a distributed coordination function (DCF) based on a carrier sense multiple access (CSMA) protocol.

The access to a wireless medium is performed by using a coordination function. Here, the basic IEEE 802.11 MAC protocol includes two operation modes of a DCF and a point coordination function (PCF). The DCF is based on a carrier sense multiple access with collision avoidance (CSMA/CA) protocol.

A method of transmitting data in a DCF period will now be described. When a station has a frame with data to be transmitted, a MAC first listens to ensure no other station is transmitting over the channel. When the channel is busy, the station chooses a backoff process to provide for a predetermined period of delay. Otherwise, when the channel is idle, the data is transmitted. Here, the backoff is set by using a binary backoff mechanism and the IEEE 802.11 protocol uses a contention transmission method such as a CSMA/CA protocol to avoid collisions between stations.

In other words, when a channel is in an idle state for a period of a DCF inter-frame space (DIFS) in a DCF period, the backoff is additionally effectuated for a random period for transmission of data. Here, the backoff is determined according to the number of slot times, and each station determines the number of slot times of a random backoff within a contention window (CW) period, before transmitting data. On the other hand, when the channel is still busy after the random backoff, the number of slot times is calculated again and a longer backoff time is effectuated.

The IEEE 802.11e draft specification uses an enhanced DCF (EDCF) to limit the mechanism for securing QoS, a hybrid coordination function (HCF), a direct link protocol (DLP), and a block data transmission confirmation mechanism.

FIG. 2 is a prior art block diagram of an AP structure in an infrastructure mode. The conventional IEEE 802.11 AP structure includes a WLAN MAC module 23 for wireless communication, a baseband module 24, an RF module 25, an IEEE 802.3 driver module 21 supporting communication based on the IEEE 802.3 protocol through an Ethernet slot 26, and a bridge module 22 providing a distribution service by managing the IEEE 802.3 and 802.11 protocols.

FIG. 3 illustrates a conventional queue mechanism in the WLAN MAC module 23 shown in FIG. 2, which is used after the IEEE 802.3 frames are converted into the IEEE 802.11 frames. In the AP, a first in first out (FIFO) queue is used to re-transmit data to a station in a BSS. The IEEE 802.3 frames, which are transmitted from a wired network, are converted into the IEEE 802.11 frames in the bridge module 22 shown in FIG. 2 and transferred to a Tx queue of the WLAN MAC module 23 shown in FIG. 2. Then, the IEEE 802.11 frames are re-transmitted according to a DCF or a PCF mechanism.

FIG. 4 illustrates the connection between wireless and wired networks in an infrastructure mode.

Referring to FIG. 4, a station connected to a BSS may communicate with a node of a wired Internet network, other than a node in the BSS, due to a distribution service function of an AP. The AP obtains channels based on a DCF or a PCF mechanism to communicate with other nodes in the BSS (Basic Service Set), and transmits data to the wired Internet network in response to demands of the nodes in the BSS. When the AP receives data from the wired Internet network and re-transmits the data to a wireless node, the AP sequentially transmits the data by using a FIFO queue operating as a buffer.

However, when the node connected to the BSS communicates with a node of the wired Internet network other than a node in the BSS, the QoS of the node performing wireless communication is not secured. When comparing the rate of transmitting data from a wireless node to a wired network to the rate of transmitting data from a wireless node to an AP, the rate of transmitting data from the wireless node to the wired network through a 100 Mbps Fast Ethernet is faster than the rate of transmitting data from the wireless node to the AP. Thus, the QoS of an uplink process of the AP may be secured.

However, a downlink process of the AP, which transmits data from the wired Internet network, is remarkably affected by a channel contention in a BSS. According to a DCF, in which transmission is performed through channel contention, that is, a distributed random access protocol in the IEEE 802.11 WLANs, when channel contention is high, the time taken for wireless communication through channel contention is longer than the time taken to transmit data from an external network to the AP, making it difficult to secure QoS of the wireless nodes. Studies of the IEEE 802.11e protocol to secure a QoS of an MAC level for wireless communication in a BSS have been vigorously performed. However, since the QoS of the IEEE 802.11e protocol is the QoS between the nodes performing the wireless communication, the QoS of communication between the wireless node and the wired Internet network cannot be secured.

In addition, the QoS of the Internet network is secured by using a protocol referred to as a differentiated service, by using a network layer (i.e., the third layer) among the seven layers of the OSI model. According to RFC 2474 and RFC 2475, which explain the differentiated service, the priority of packets is determined by dividing each IP packet into three types. A router using a forwarding method follows a re-transmission standard according to a differentiated services field codepoint (DSCP) for a per-hop behavior function based on the priority. The three kinds of DSCP, which are default (best-effort), expedited forwarding (EF), and assured forwarding (AF), are defined in the type of service (ToS) (8-bit) of an IPv4 header. In addition, when transmitting data from the wired Internet network, the frames requiring the quickest process in the router are first re-transmitted. Thus, the transmission speed of the frames requiring the QoS is increased. However, the differentiated service mechanism operates as a router in the wired Internet network. Thus, the transmission method adapted to the transmission priority in the AP is required to re-transmit data to a node performing a wireless communication.

When a frame transmitted by the best-effort method without a secured QoS exists in a FIFO queue, frames requiring a secured QoS are delayed even when a frame requiring the secured QoS exists in an AP FIFO queue after converting the IEEE 802.3 protocol into the IEEE 802.11 protocol. As a result, problems occur in the QoS of VoIP, Web casting, image telephones, video conferences, and streaming.

### SUMMARY OF THE INVENTION

The present invention is provided to improve the quality of service (QoS) of communications between wireless and wired networks by using four category-based queues, which are suggested by the IEEE 802.11e, and an expedited forward (EF) queue having a priority order.

The present invention provides an apparatus and method for transmitting data between wireless and wired networks by converting the IEEE 802.3 frames into the IEEE 802.11 frames and mapping differentiated service protocols, which are realized in the Internet network, into four queues and one EF queue of the IEEE 802.11e protocol, in order to realize effective transmission scheduling and to improve QoS.

According to an aspect of the present invention, there is provided a method of transmitting data between wireless and wired networks that use different communication protocols, the method comprising receiving frames of a first communication protocol type from a first network and converting the received frames into frames of a second communication protocol type, determining the transmission priority order of the frames that are converted into the second communication protocol type, based on packet information of the received frames, and transmitting the frames to a second network based on the determined transmission priority order.

Preferably, the first communication protocol type is the IEEE 802.3 protocol and the second communication protocol type is the IEEE 802.11 protocol.

The receiving of the IEEE 802.3 frames and the converting of the received frames into the IEEE 802.11 frames may comprise receiving the IEEE 802.3 frames and releasing capsules of the received frames, and reading the header information of IP packet of the frames from which the capsule have been released and converting the received frames into the IEEE 802.11 frames.

The determining of the transmission priority order of the frames preferably includes determining the transmission priority order by mapping the converted frames into a plurality of queues according to the read DSCP value.

More preferably, the determining of the transmission priority order of the frames comprises determining whether the DSCP value recorded in the ToS field is zero, and determining a transmission priority order by mapping the received frames into a best effort (BE) queue when the determined DSCP value is zero and mapping the received frames into a plurality of queues whose transmission priority orders are predetermined when the determined DSCP value is a value other than zero. Here, the plurality of queues may include an (access category) AC1 queue, an AC2 queue, an AC3 queue, and an expedited forwarding (EF) queue.

The transmitting of the frames to a second network based on the determined transmission priority order may comprise transmitting the frames mapped into the EF queue with the highest priority, and transmitting the frames mapped into the AC1, AC2, and AC3 queues in an order of the AC3 queue, the AC2 queue, and the AC1 queue.

The transmitting of the frames mapped in the EF queue with the highest priority may comprise establishing the maximum value of a contention free period (CFP) in a beacon frame, calculating the transmission time of the frames in the EF queue, comparing the calculated transmission time with the set maximum value of the CFP, and transmitting the frames stored in the EF queue to the second network during the set CFP, when the transmission time is less than the maximum value of the CFP.

The transmitting of the frames stored in the EF queue to the second network during the set CFP further includes transmitting as many frames as possible during the CFP and transmitting the remaining frames in the next CFP, when the transmission time is the same as or greater than the maximum value of the CFP.

The transmitting of the frames stored in the EF queue to the second network during the set CFP may further include transmitting the beacon frame in which the maximum value of the CFP is set before transmitting the frames stored in the EF queue.

In accordance with another aspect of the present invention, there is provided an apparatus transmitting data between wireless and wired networks that use different communication protocols, the apparatus comprising a bridge module receiving frames of a first communication protocol type from a first network and converting the received frames into frames of a second protocol type, a packet sorting module determining the transmission priority order of the frames that are converted into those of the second protocol type, based on the packet information of the received frames, and a frame transmission module transmitting the frames to a second network based on the determined transmission priority order.

The apparatus may further comprise a packet information reading module that releases a capsule of the received frame and reads the header information of an IP packet in the frames from which the capsule have been released.

Meanwhile, the frame transmission module may comprise a first unit establishing the maximum value of a contention free period (CFP) in a beacon frame, a second unit calculating the transmission time of the frames in the EF queue, a third unit comparing the calculated transmission time with the set maximum value of the CFP, and a fourth unit transmitting the frames stored in the EF queue to the second network during the set CFP, when the transmission time is less than the maximum value of the CFP.

### BRIEF DESCRIPTION OF THE DRAWINGS

The above and other features and advantages of the present invention will become more apparent by describing in detail an exemplary embodiment thereof with reference to the attached drawings in which:

FIG. 1 illustrates conventional infrastructure mode and ad hoc mode wireless communication systems;

FIG. 2 is a block diagram illustrating a conventional infrastructure mode access point (AP);

FIG. 3 illustrates a queue mechanism in a wireless LAN MAC module, which is used after the IEEE 802.3 frames are converted into the IEEE 802.11 frames;

FIG. 4 illustrates the connection between an infrastructure mode wireless communication network and the Internet network;

FIG. 5 illustrates a method of transmitting data between wireless and wired networks according to the present invention;

FIG. 6 illustrates a differentiated services field codepoint (DSCP) value of a packet header in the IEEE 802.3 frame according to the present invention;

FIG. 7 illustrates an example of mapping the IEEE 802.3 frames in the IEEE 802.11 queues according to the present invention;

FIG. 8 illustrates a method of controlling the transmission of frames, which are mapped in a plurality of queues, according to the present invention;

FIGS. 9 and 10 are flowcharts illustrating a method of transmitting data between wireless and wired networks according to the present invention;

FIG. 11 is a block diagram illustrating an apparatus transmitting data between wireless and wired networks according to the present invention; and

FIG. 12 is a block diagram illustrating a frame transmission module of an apparatus transmitting data according to the present invention.

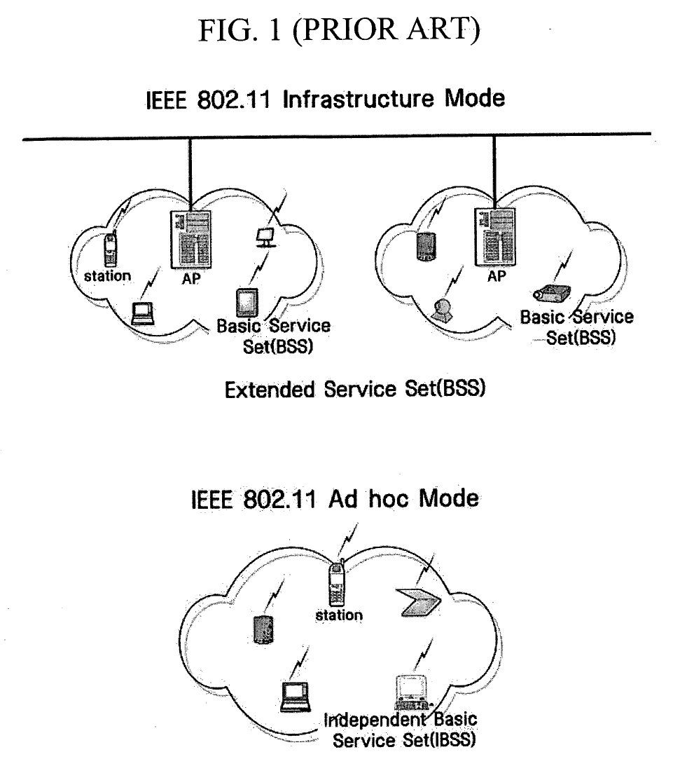

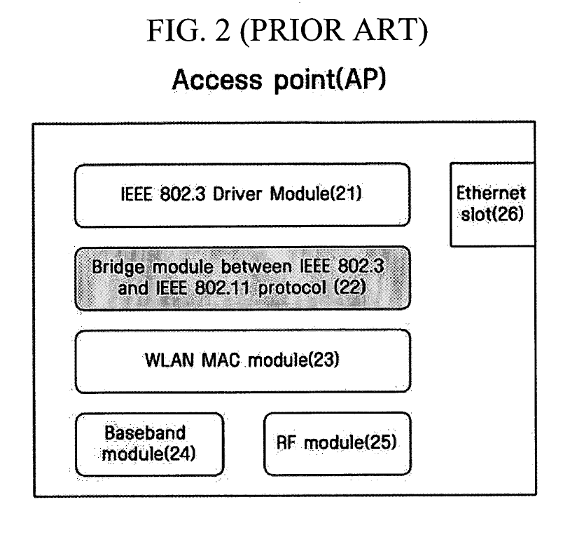

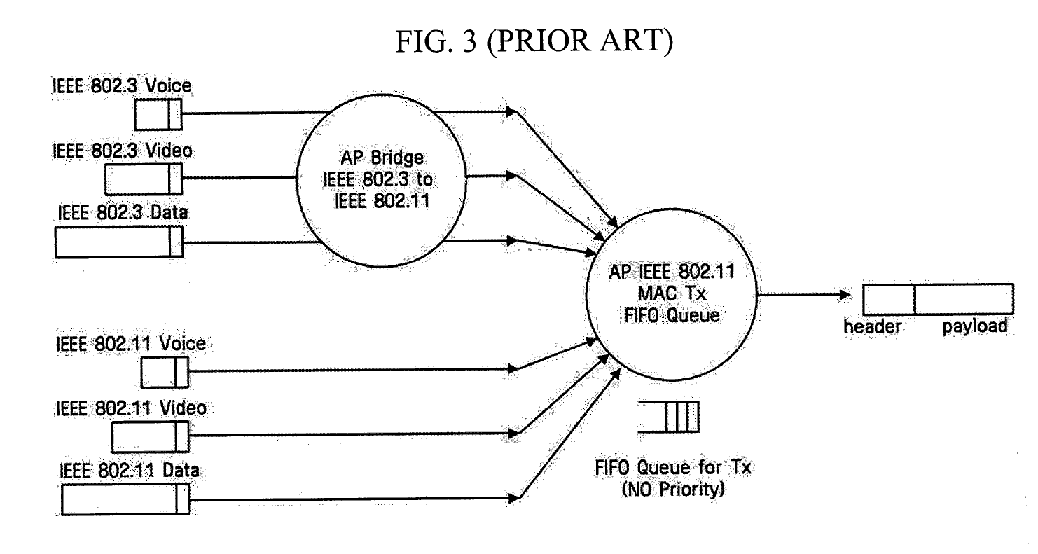

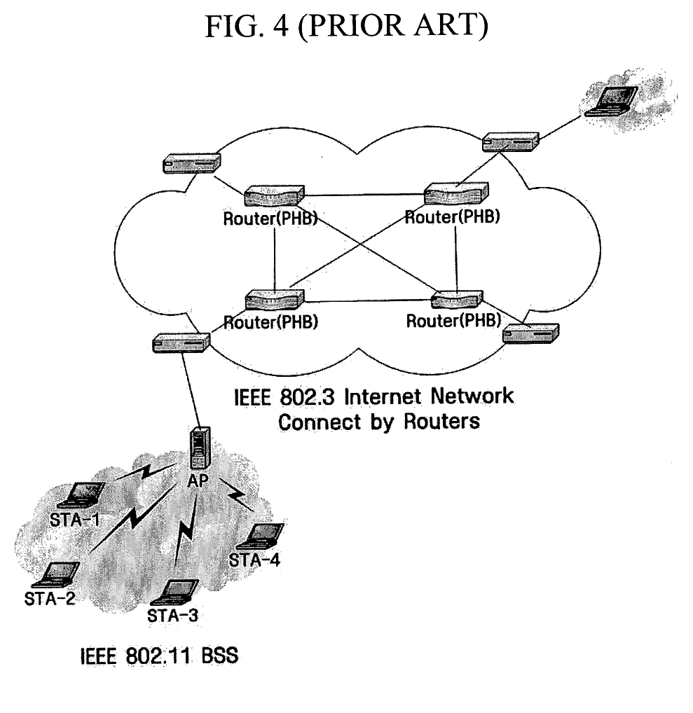

### DETAILED DESCRIPTION OF EXEMPLARY EMBODIMENTS OF THE INVENTION

The present invention will now be described more fully with reference to the accompanying drawings, in which an exemplary embodiment of the invention is shown.

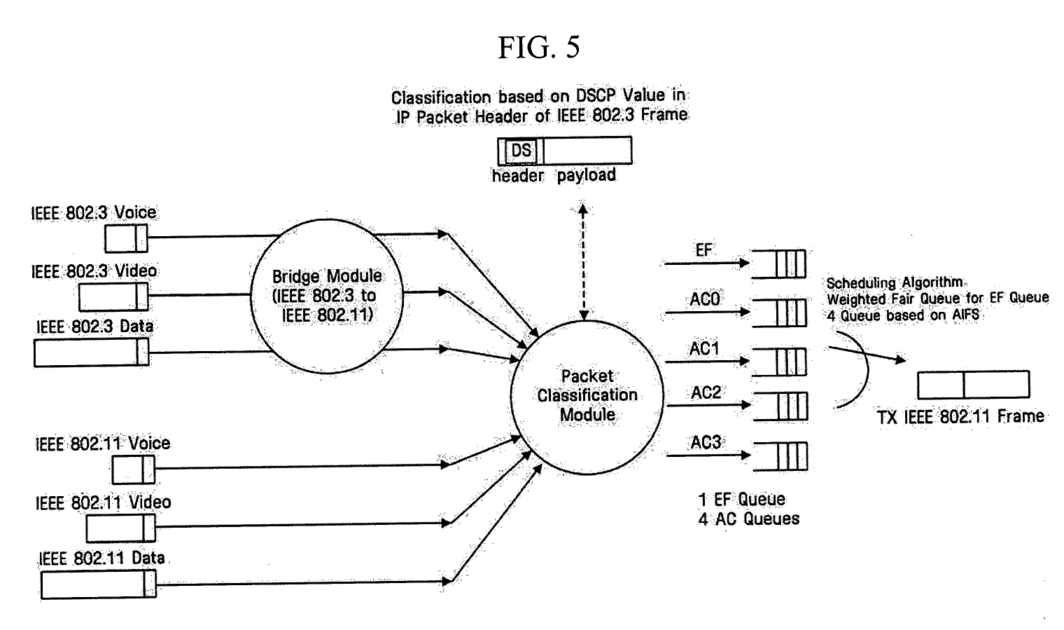

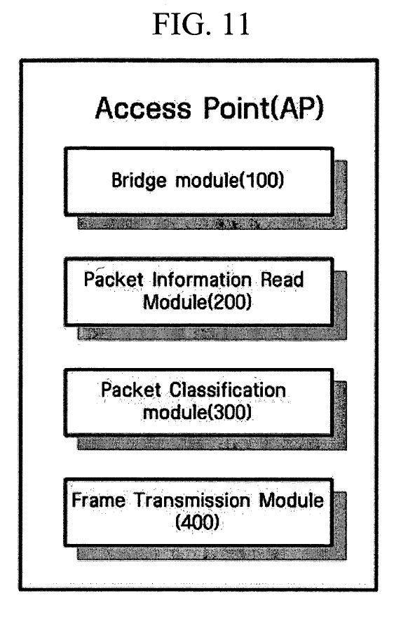

FIG. 5 illustrates a method of transmitting data between wireless and wired networks according to the present invention. Referring to FIG. 5, the IEEE 802.3 frames having three kinds of information, i.e., voice, video, and data, are converted into the IEEE 802.11 frames by a bridge module 100 shown in FIG. 11, and the information is mapped in queues having five categories by a packet classification module 300 shown in FIG. 11. A differentiated services field codepoint (DSCP) value existing in an IP packet header of the IEEE 802.3 frames is the reference of the mapping operation, and the queues include four access categories (ACs) according to a conventional enhanced distributed channel access (EDCA) mode and one expedited forward (EF) queue.

As shown in FIG. 5, a mapping method according to a conventional EDCA mode does not include a scheduling mechanism determining the transmitting order of the mapped frames; however, the present invention realizes a mechanism of scheduling access points (APs) by adding an EF queue to conventional AC queues.

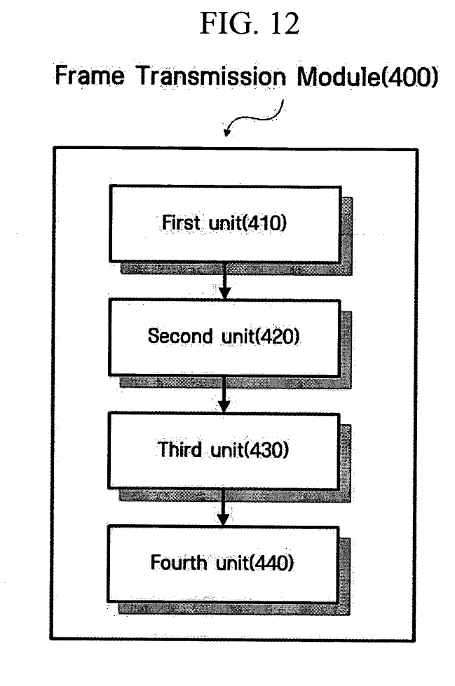

FIG. 11 is a block diagram illustrating an apparatus transmitting data between wireless and wired networks according to the present invention, and FIG. 12 is a block diagram illustrating a frame transmission module of an apparatus of transmitting data according to the present invention.

The apparatus of transmitting data according to the present invention, which is realized in an AP, includes a bridge module 100, a packet information reading module 200, a packet sorting module 300, and a frame transmission module 400. In addition, the frame transmission module 400 is formed of a first unit 410, a second unit 420, a third unit 430, and a fourth unit 440, as shown in FIG. 12.

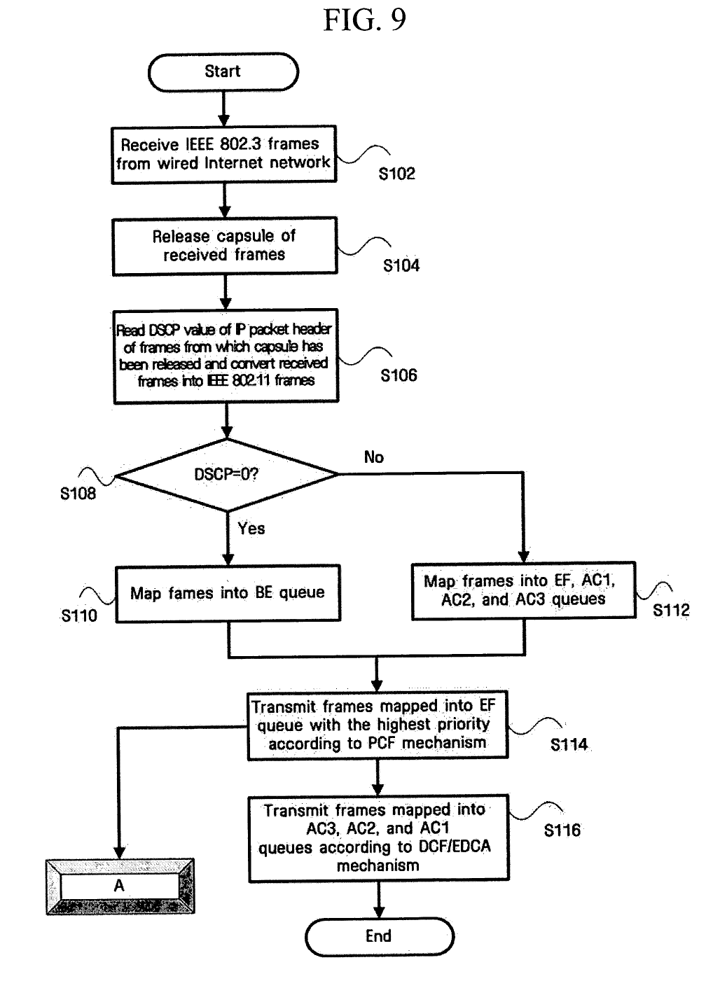

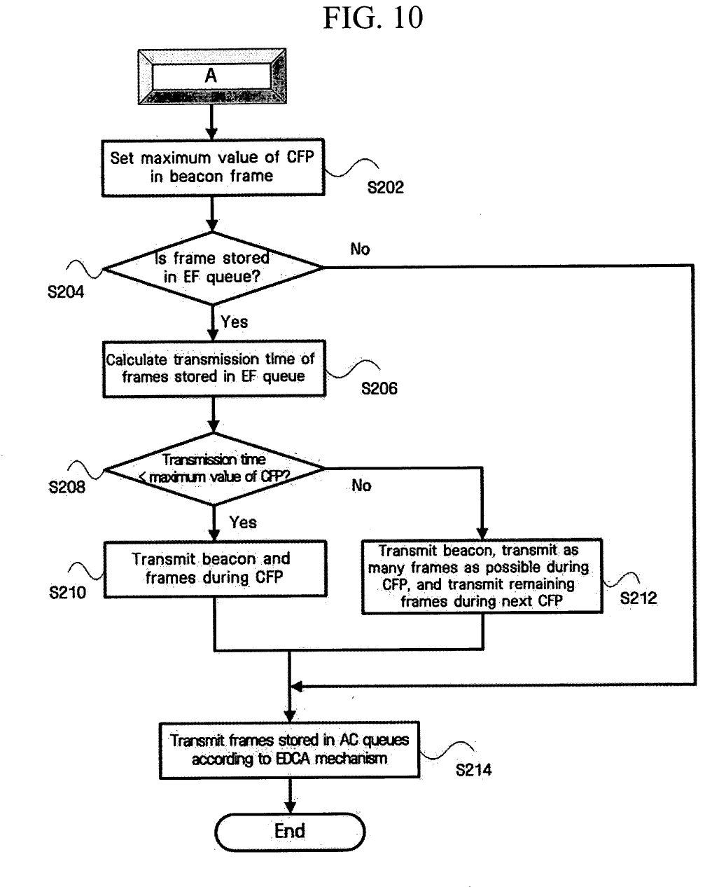

FIGS. 9 and 10 are flowcharts illustrating a method of transmitting data between wireless and wired networks according to the present invention.

Referring first to FIG. 9, frames of a first communication protocol type are received from a first network in S102, then the capsules of the received frames are released in S104. The packet information reading module 200 reads the header information of an IP packet in the frames from which the capsule have been released, and the bridge module 100 converts the received frames into frames of a second protocol type in S106.

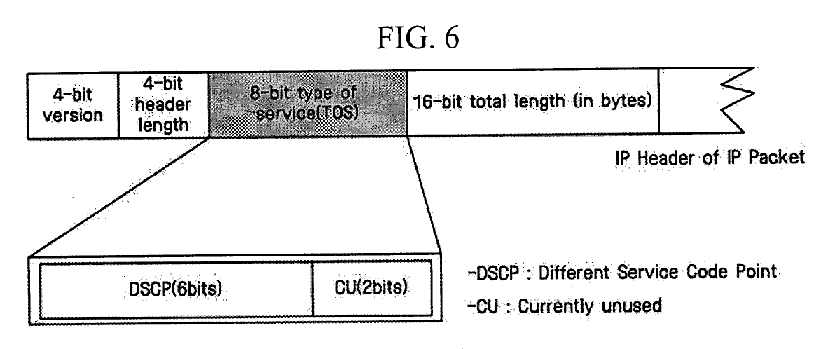

Here, the header information denotes a DSCP value recorded in a ToS field of an IP packet header that is shown in FIG. 6, which illustrates a DSCP value of a packet header in the IEEE 802.3 frame according to the present invention. The ToS field of an IP packet header is formed of eight bits of which two bits are not presently used. Six bits of the eight bits include the DSCP values, which are read by the packet information reading module 200.

Thereafter, the frames converted into those of the second protocol type are mapped into a plurality of queues based on the DSCP value as the packet information of the received frames in order to determine a transmission priority order.

More specifically, the packet information reading module 200 determines whether the DSCP value recorded in the ToS field is zero in S108. When the DSCP value recorded in the ToS field is zero, the packet sorting module 300 maps the converted frames into a best effort (BE) queue in S110. Otherwise, the packet sorting module 300 maps the converted frames into a plurality of queues whose transmission priority orders are predetermined, in S112. Here, the plurality of queues include AC1, AC2, and AC3 queues, excluding AC0 corresponding to a BE queue, and an EF queue taking top priority in the traffic order.

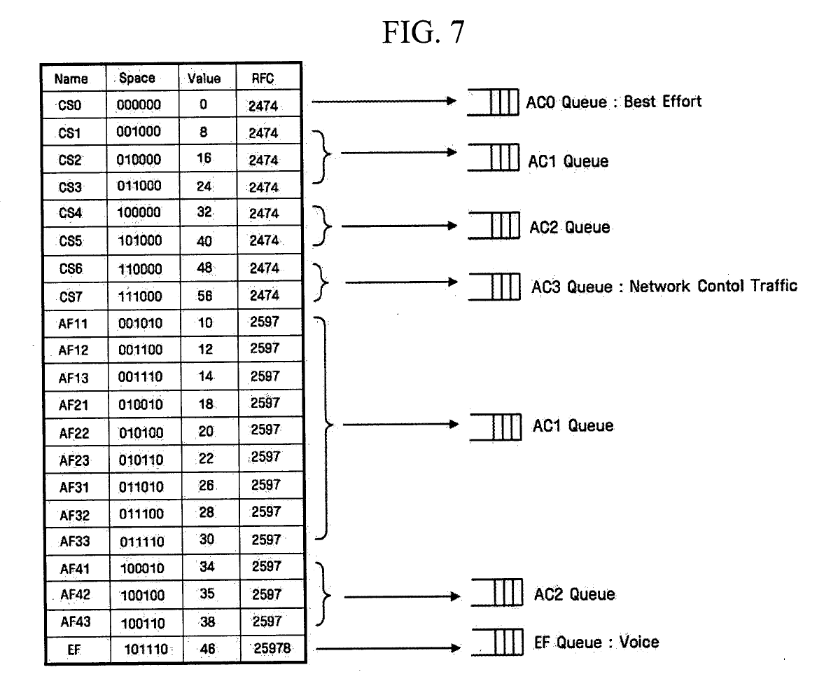

FIG. 7 illustrates an example of mapping the IEEE 802.3 frames to the IEEE 802.11 queues according to the present invention. In the embodiment of the present invention, the first protocol type denotes the IEEE 802.3 protocol and the second protocol type denotes the IEEE 802.11 protocol. As shown in FIG. 7, the voice data is mapped into the EF queue at the bottom of FIG. 7, because the voice data is sensitive to the delay of transmission and requires a secure QoS.

Thereafter, the frame transmission module 400 transmits the frames mapped into the EF queue with the highest priority, based on a point coordination function (PCF) mechanism, in S114, and then transmits the frames mapped in the AC3 queue, the AC2 queue, and the AC1 queue based on the EDCA mechanism, in S116.

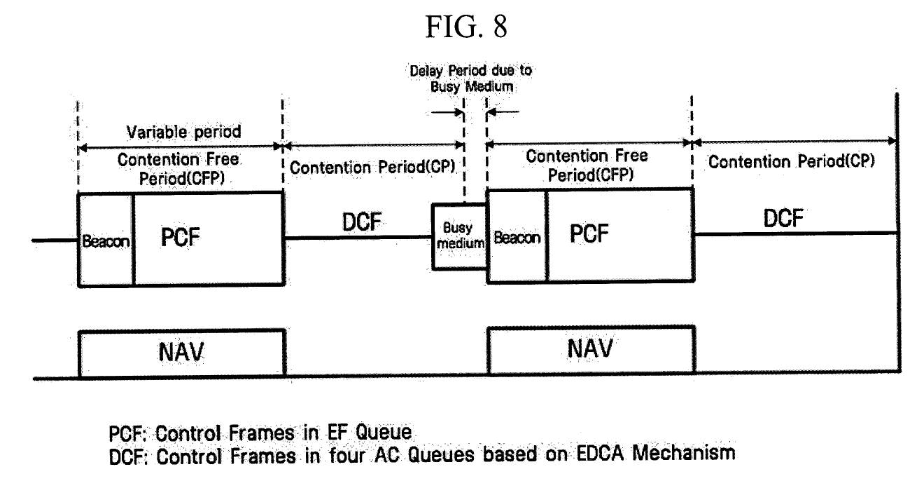

FIG. 8 illustrates a method of controlling the transmission of frames that are mapped into a plurality of queues, according to the present invention. The frames mapped into the EF queue are controlled by the PCF, and the frames mapped into the AC1, AC2, and AC3 queues are controlled by a distributed coordination function (DCF). In a contention free period (CFP), which is controlled by the PCF, the frame mapped into the EF queue is transmitted. In a contention period (CP), the frames mapped into the AC1, AC2, and AC3 queues are transmitted. In addition, a beacon frame is transmitted first in the CFP, and the time including the transmission time of the beacon frame is set by a network allocation vector (NAV).

The NAV is used to realize a virtual carrier detection function, and a station delays connection in the case where a medium is busy. The IEEE 802.11 protocol includes two carrier detection functions, which are a physical function and a virtual carrier detection function. The physical function depends on whether the station decodes legal IEEE 802.11 signals and an energy critical value while requiring a physical measurement. The virtual carrier detection function is based on the NAV. Most frames include values other than zero in NAV fields in order to request every station to delay the connections to the medium for a predetermined number of microseconds after transmitting the present frame. Then, the stations process the NAV and delay the connections in order to prevent collision.

The process of transmitting the frames mapped in the EF queue in S114 shown in FIG. 9 is described in more detail in FIG. 10.

Referring to FIG. 10, the first unit 410 of the frame transmission module 400 sets the maximum value of the CFP in a beacon frame in S202. Then, the first unit 410 of the frame transmission module 400 determines whether a frame is stored in the EF queue in S204. When the EF queue is in a null state without a frame, the frames stored in AC queues are transmitted according to the EDCA mechanism in S214.

Otherwise, when the EF queue is not in a null state, that is, when the frames are stored in the EF queue, the second unit 420 of the frame transmission module 400 calculates the transmission time of the frames stored in the EF queue in S206.

The third unit 430 of the frame transmission module 400 compares the calculated transmission time with the maximum value of the CFP in S208.

As a result, when the transmission time is less than the maximum value of the CFP, the fourth unit 440 of the frame transmission module 400 transmits the frames stored in the EF queue to a wireless communication network during the CFP in S210. Otherwise, when the transmission time is not less than the maximum value of the CFP, the fourth unit 440 transmits as many frames as possible during the CFP and transmits the remaining frames during the next CFP in S212. Here, the fourth unit 440 transmits the frames after transmitting a beacon frame in which the maximum value of the CFP is set. Thereafter, the frames stored in AC queues are transmitted according to the EDCA mechanism in S214.

While the present invention has been particularly shown and described with reference to an exemplary embodiment thereof, it will be understood by those of ordinary skill in the art that various changes in form and details may be made therein without departing from the spirit and scope of the present invention as defined by the following claims.

According to the present invention, when converting frames of a first protocol type, which is the IEEE 802.3 protocol, into frames of a second protocol type, which is the IEEE 802.11 protocol, a transmission priority order is determined based on a DSCP value in a ToS of an IP packet. Thus, the QoS of transmission can be secured.

In addition, the present invention may transmit IEEE 802.11 frames, which are converted from IEEE 802.3 frames received at APs, based on a priority order without changing a DCF/PCF mechanism as a present wireless communication agreement, because routers of the wired Internet network support a differentiated service mechanism.

1. A method of transmitting data between wireless and wired networks that use different communication protocols, the method comprising:
receiving first frames of a first communication protocol type from a first network and converting the received first frames into second frames of a second communication protocol type;
determining the transmission priority order of the second frames that have been converted into the second communication protocol type, based on packet information of the received first frames; and
transmitting the second frames to a second network based on the determined transmission priority order.

2. The method of claim 1, wherein the first communication protocol type is the IEEE 802.3 protocol, and the second communication protocol type is the IEEE 802.11 protocol.

3. The method of claim 2, wherein the receiving of the IEEE 802.3 frames and the converting of the received first frames into the IEEE 802.11 frames comprises:
receiving the IEEE 802.3 frames and releasing capsules of the received IEEE 802.3 frames; and
reading the header information of an Internet protocol (IP) packet of the IEEE 802.3 frames from which the capsule has been released and converting the received IEEE 802.3 frames into the IEEE 802.11 frames.

4. The method of claim 3, wherein the header information is a differentiated services field codepoint (DSCP) value recorded in a type of service (ToS) field of an IP packet header.

5. The method of claim 4, wherein the determining of the transmission priority order of the second frames includes determining the transmission priority order by mapping the converted second frames into a plurality of queues according to the read DSCP value.

6. The method of claim 4, wherein the determining of the transmission priority order of the second frames comprises:
determining whether the DSCP value recorded in the ToS field is zero; and
determining the transmission priority order by mapping the converted second frames into a best effort (BE) queue when the determined DSCP value is zero and mapping the converted second frames into a plurality of queues whose transmission priority orders are predetermined when the determined DSCP value is a value other than zero.

7. The method of claim 6, wherein the plurality of queues include an (access category) AC1 queue, an AC2 queue, an AC3 queue, and an expedited forwarding (EF) queue.

8. The method of claim 7, wherein at least one of the second frames mapped in the EF queue are controlled by a point coordination function (PCF), and at least another one of the second frames mapped in the AC1, AC2, and AC3 queues are controlled by a distributed coordination function (DCF).

9. The method of claim 7, wherein the transmitting of the second frames to the second network based on the determined transmission priority order comprises:
transmitting at least one of the second frames mapped into the EF queue with the highest priority; and
transmitting at least another one of the second frames mapped into the AC1, AC2, and AC3 queues in an order of the AC3 queue, the AC2 queue, and the AC1 queue.

10. The method of claim 9, wherein the transmitting of the second frames mapped in the EF queue with the highest priority comprises:
setting the maximum value of a contention free period (CFP) in a beacon frame;
calculating the transmission time of the second frames in the EF queue;
comparing the calculated transmission time with the set maximum value of the CFP; and
transmitting the second frames stored in the EF queue to the second network during the set CFP, when the transmission time is less than the maximum value of the CFP.

11. The method of claim 10, wherein the transmitting of the second frames stored in the EF queue to the second network during the set CFP further includes transmitting as many of the second frames as possible during the CFP and transmitting remaining second frames in a next CFP, when the transmission time is the same as or greater than the maximum value of the CFP.

12. The method of claim 10, wherein the transmitting of the second frames stored in the EF queue to the second network during the set CFP further includes transmitting the beacon frame in which the maximum value of the CFP is set before transmitting the second frames stored in the EF queue.

13. The method of claim 11, wherein the transmitting of the second frames stored in the EF queue to the second network during the set CFP further includes transmitting the beacon frame in which the maximum value of the CFP is set before transmitting the second frames stored in the EF queue.

14. An apparatus transmitting data between wireless and wired networks that use different communication protocols, the apparatus comprising:
a bridge module receiving first frames of a first communication protocol type from a first network and converting the received first frames into second frames of a second protocol type;
a packet sorting module determining the transmission priority order of the second frames that are converted into those of the second protocol type, based on the packet information of the received first frames; and
a frame transmission module transmitting the second frames to a second network based on the determined transmission priority order.

15. The apparatus of claim 14, wherein the first communication protocol type is the IEEE 802.3 protocol, and the second communication protocol type is the IEEE 802.11 protocol.

16. The apparatus of claim 14, further comprising a packet information reading module that releases a capsule of the received first frames and reads the header information of an Internet protocol (IP) packet in the first frames from which the capsule have been released.

17. The apparatus of claim 16, wherein the header information is a differentiated services field codepoint (DSCP) value recorded in a type of service (ToS) field of an IP packet header.

18. The apparatus of claim 16, wherein the packet sorting module maps the converted second frames into a plurality of queues to be stored, and determines the transmission priority order of the second frames according to the read DSCP value.

19. The apparatus of claim 18, wherein the packet sorting module determines whether the DSCP value recorded in the ToS field is zero, and determines a transmission priority order by mapping the converted second frames into a best effort (BE) queue when the determined DSCP value is zero and mapping the converted second frames into a plurality of queues whose transmission priority orders are predetermined when the determined DSCP value is a value other than zero.

20. The apparatus of claim 19, wherein the plurality of queues include an (access category) AC1 queue, an AC2 queue, an AC3 queue, and an expedited forwarding (EF) queue.

21. The apparatus of claim 20, wherein the second frames mapped in the EF queue are controlled by a point coordination function (PCF), and the frames mapped in the AC1, AC2, and AC3 queues are controlled by a distributed coordination function (DCF).

22. The apparatus of claim 20, wherein the frame transmission module transmits at least one of the second frames mapped into the EF queue with the highest priority and then transmits at least another one of the second frames mapped into the AC1, AC2, and AC3 queues in an order of the AC3 queue, the AC2 queue, and the AC1 queue.

23. The apparatus of claim 22, wherein the frame transmission module comprises:
a first unit establishing the maximum value of a contention free period (CFP) in a beacon frame;
a second unit calculating the transmission time of the second frames in the EF queue;
a third unit comparing the calculated transmission time with the established maximum value of the CFP; and
a fourth unit transmitting the second frames stored in the EF queue to the second network during the set CFP, when the transmission time is less than the maximum value of the CFP.
